(19) United States
(12) Patent Application Publication
(10) Pub. No.: US 2013/0006749 A1
(43) Pub. Date: Jan. 3, 2013

(54) PROXIMITY BASED SOCIAL NETWORKING SYSTEMS AND METHODS

(76) Inventors: Ryan Fink, Vancouver, WA (US); Drew Swenson, (US)

(21) Appl. No.: 13/175,816

(22) Filed: Jul. 1, 2011

(51) Int. Cl. G06Q 30/00; G06F 15/16

(52) U.S. Cl. 705/14.39; 709/203

(57) ABSTRACT

Social networking systems and methods including a server and a user device. The server includes memory and a server processor. The server processor is programmed with instructions to receive current geographic position data for each user, calculate an interaction zone for each user, cross reference the interaction zones for each user and identify users with current geographic positions within other users' interaction zones, and serve to a given user the user profiles of other users within the given interaction zone of the given user. The network capable device includes a display, a geographic positioning device, and a device processor. The device processor is programmed with instructions to upload current geographic position data of the given user to the server, receive user profile data corresponding to other users within the interaction zone of the given user, display the user profile data of the other users within the given user's interaction zone on the display, receive input from the given user to send a message to a selected other user, and send the message to the selected other user.

### BACKGROUND

The present disclosure relates generally to social networking systems and methods. In particular, social networking systems and methods with geographic proximity based features are described.

Social networking systems and methods are a useful and popular way for people to stay in touch with friends, colleagues and relatives. Further social networking systems and methods allow people a convenient and interesting way to meet new people. Social networking systems and methods often utilize a combination of software and computer hardware. For example, social networking may effectively accomplished via software designed to run on mobile devices, such as smart phones, often referred to as “mobile apps” or simply “apps,” as well as software designed to run on desktop computers.

Known social networking systems and methods are not entirely satisfactory for the range of applications in which they are employed. For example, existing social networking systems and methods do not allow geographic-proximity-based social networking. Instead, existing social networking systems and methods most often operate without regard to a user's current geographic position, indeed, most conventional social networking systems and methods do not distinguish whether a user is in New York, California, or France as long as the user has an internet connection.

Those conventional systems and methods that do at least display a user's current position require a user to manually input location or destination information. Inconveniently, such systems and methods typically require their users to manually update the system to user's current location when a user changes location,

In addition, conventional social networking systems and methods require a user to affirmatively “login.” Indeed, known social networking users must affirmatively login to update profile information or check for friend requests. Inefficiently, many existing social networking applications require a user to discontinue their current activity to input or check for new information.

Further, existing social networking systems and methods do not allow a given user to view the profile or status of unknown social networking users who are in a limited geographic proximity relative to the given user (e.g., in the same coffee shop). Existing social networking solutions do not allow a user to identify potential friends in real time. Conventional social networking solutions limit a user to viewing profile information of friends-of-mutual-friends, or requesting friendship from random virtual profiles as a way to extend the user's social network. Additionally, existing social networking systems require a “request” that provides little background information, or basis for the request, for the potential friend to review.

Moreover, existing social networking systems are limited to viewing information on a hand-held device or stationary computer. Indeed, existing social networking systems do not allow a user to view another geographically-proximate user's profile with a wearable virtual display.

Further, conventional social networking systems do not allow a business to selectively advertise to potential customers who are present in immediate geographic proximity to the business. Current mobile apps tailor featured advertising based on mobile app users' past internet searches or purchases. However, existing mobile apps are deficient because they do not allow businesses to target new customers who are within immediate geographic proximity of the business.

Moreover, existing mobile apps are deficient because they do not allow businesses to differentiate between target demographic customers and non-target demographic customers close geographic proximity of the business. Thus, existing mobile apps do riot allow solicitation of potential customers who may be near or walking past the business in real time.

Thus, there exists a need for social networking systems and methods that improve upon and advance the design of known social networking systems and methods. Examples of new and useful social networking systems and methods incorporating geographic-proximity-based features relevant to the needs existing in the field are discussed below.

Disclosure addressing one or more of the identified existing needs is provided in the detailed description below. Examples of references relevant to social networking systems and methods include U.S. Patent References: U.S. Pat. Nos. 7,072,941, 7,765,265, 7,831,917, 7,202,814 and patent publication 20090164574 and patent application Ser. No. 12/869,481. The complete disclosures of the above patents and patent applications are herein incorporated by reference for all purposes.

### SUMMARY

The present disclosure is directed to social networking systems and methods for users to find and communicate with each other within a limited geographic area, the social networking system including a server and a user device. The server is configured to exchange data over a wide area network and includes memory to store user profile data and a server processor. The server processor is programmed with instructions to receive current geographic position data for each user, calculate an interaction zone for each user corresponding to a predetermined area around the each users' current geographic position, cross reference the interaction zones for each user and identify users with current geographic positions within other users' interaction zones, and, for a given interaction zone of a given user, serve to the given user the user profiles of other users with current geographic positions within the given interaction zone of the given user. The network capable device is used by the given user and is configured to exchange data over the wide area network. The network capable device includes a display, a geographic positioning device, add a device processor operatively connected to the display and to the geographic positioning device. The device processor is programmed with instructions to upload current geographic position data of the given user obtained from the geographic positioning device to the server, receive user profile data corresponding to other users within the interaction zone of the given user, display the user profile data of the other users within the given user's interaction zone, on the display, receive input from the given user to send a message to a selected other user within the given user's interaction zone, and send the message to the selected other users within the given user's interaction zone.

### BRIEF DESCRIPTION OF THE DRAWINGS

FIG. 1 is a schematic view of a computing device.

FIG. 2 is a schematic view of a first example of proximity based social networking system and of methods executed by server processor and a device processor.

FIG. 3 is a schematic view of a social networking system depicting a plurality of users and user devices in communication with a social networking server.

FIG. 4 is a schematic view of an interaction zone of a given user and other users within the given user's interaction zone.

FIG. 5 depicts a given user's view through lenses of a pair of network capable eyeglasses depicting the lenses of the eyeglasses displaying a second user's profile information.

FIG. 6 is a flowchart of a proximity based social networking method for a commercial user to send an offer to a group of nearby users.

### DETAILED DESCRIPTION

The disclosed social networking systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various social networking systems and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example,

Various examples of disclosed social networking systems and methods may be implemented using electronic circuitry configured to perform one or more functions. For example, with some embodiments of the invention, the social networking systems and methods may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

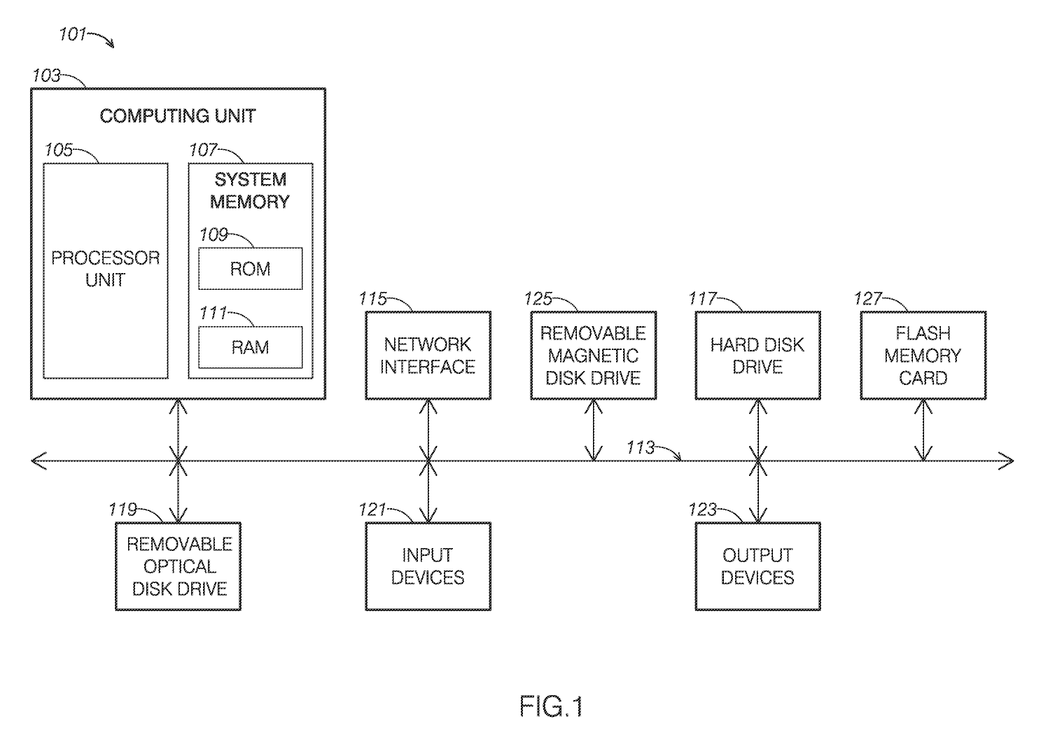

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those, of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include,for example, a monitor display, an integrated display, television, printer, stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP), These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or IPHONE® or Droid® brand smartphone available from Apple, Inc. of Cupertino, Calif. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone.” As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data port such as a Bluetooth® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

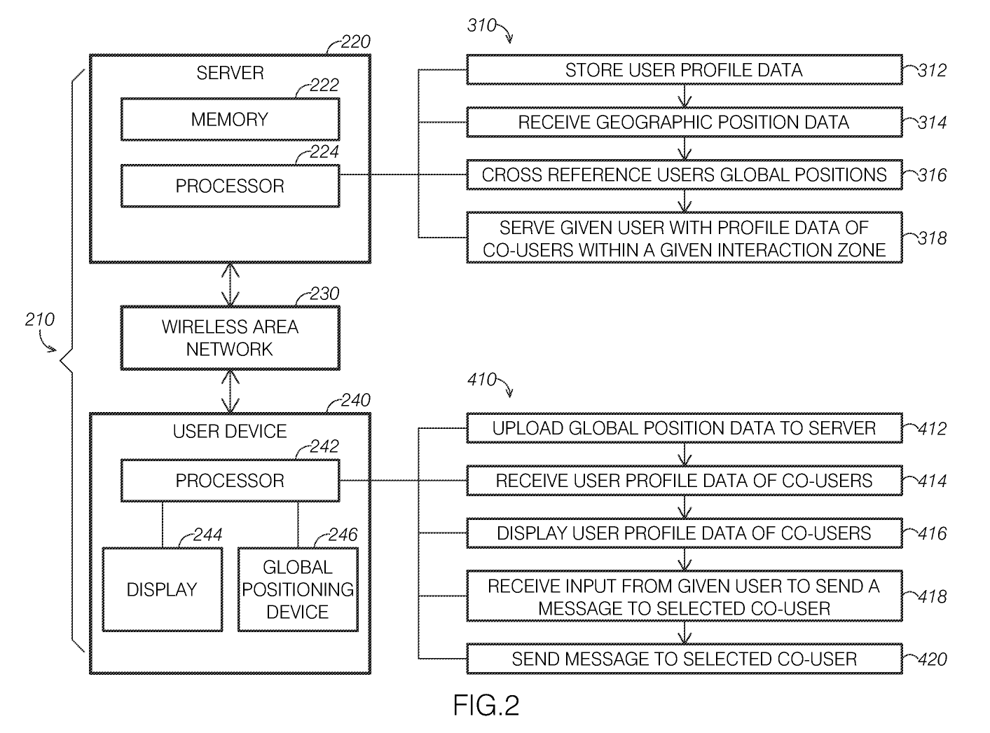

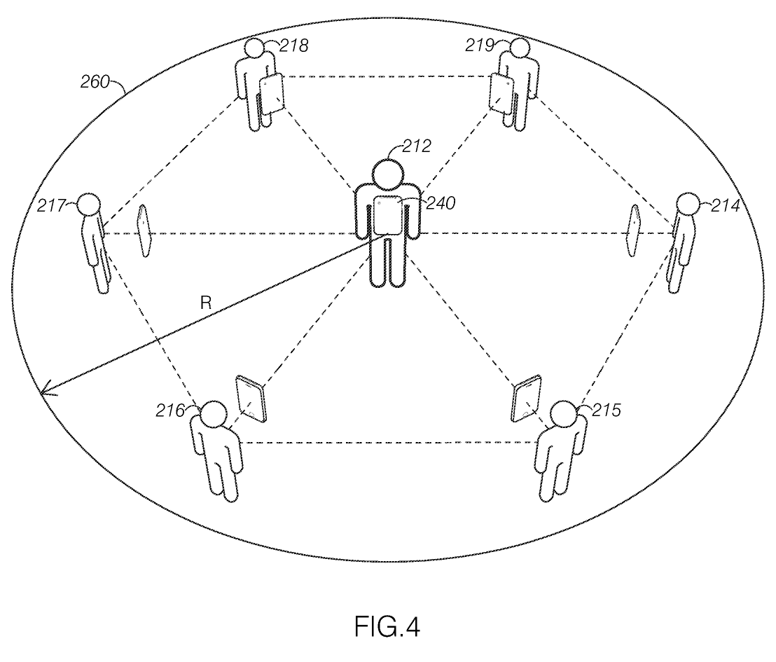

Turning attention to FIGS. 2-6, a first example of a social networking system, social networking system 210, will now be described. Social networking system 210 enables users to interact with one another when within a selected geographic proximity of each other. With reference to FIG. 4, the reader can see that the selected geographic proximity is represented by an interaction zone 260. By focusing the social interaction to a discrete interaction zone, more meaningful interaction is fostered. Indeed, users of social networking system 21 may be within sufficiently close proximity that they can see one another and/or speak to one another in addition or alternatively to their interaction initiated via social networking system 210.

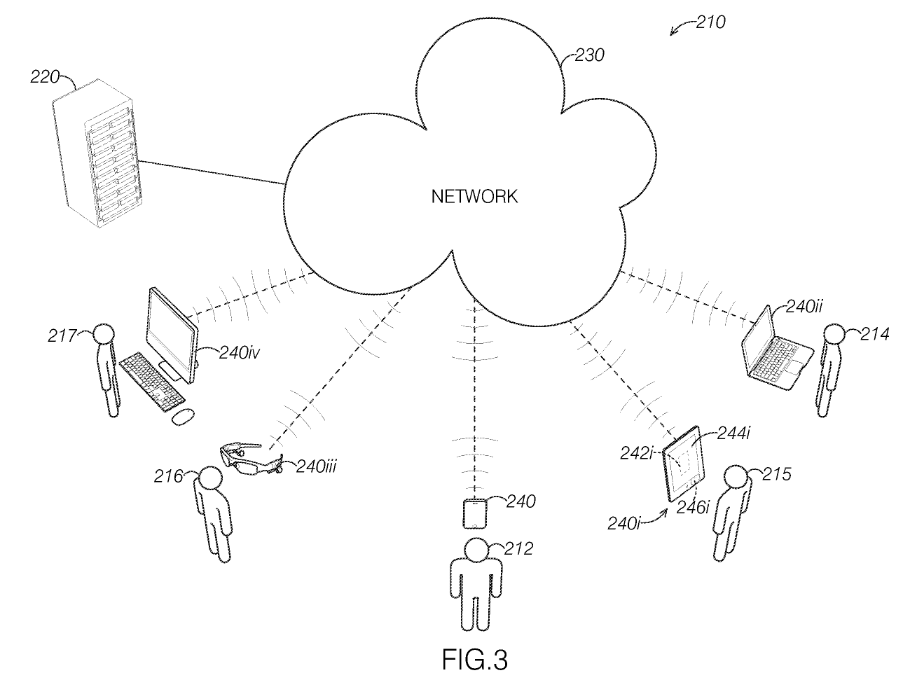

As shown in FIG. 2, social networking system 210 includes a server 220, a wide-area-network 230, and a user device 240. As can be seen in FIG. 3, social networking system accommodates a plurality of users and user devices, represented as users 212-217 and user devices 240, 240i, 240ii, 240iii, and 240iv. Indeed a larger number of users and user devices may be included in the social networking systems described herein.

The reader will observe in FIG. 3 that social networking system 210 is configured to include and accommodate a wide variety of user devices. As shown in FIG. 3, the user devices may include a desktop computer 240iv, a pair of glasses incorporating a computer display 24oiii, a smart phone 240, a tablet computer 240i, and a laptop computer 240ii. Suitable user devices include any device with a user interface and a display including or operatively connected to a networking capable computing device.

As will be explained in more detail below, social networking system 210 enables users to send brief messages along with information about themselves, collectively referred to as “hits,” to one another when within each other's interaction zone. The personal information about each user is stored in memory as a user profile. In the example shown FIGS. 2-6 the user profile is stored in a memory 222 on a server 220 and accessed by use devices 240-240iv over wide-area-network 230. Additionally or alternatively, the user profiles may be stored in memory onboard the user devices themselves and transferred to other user devices over wide-area-network 230, such as via peer-to-peer networking techniques.

Social networking system 210 can be used to allow a given user to meet new users or to interact with users who the given user has already met, either in person or online. Further, social networking system 210 can be used to create a record of when and where a user was within close proximity to another user. For example, social networking system 210 is configured to record the time and place of any hits the user receives and to display the hits to the user.

In one example, the hits a user has received in a given time period are displayed on a map in a position corresponding to the location where the hit was received along with a timestamp of when the hit was received. Continuing with this example, the displayed hits are links that, when selected, open up a page displaying the user profile of the user who sent the selected hit. In other examples, the hits received in a given time period are displayed in a list, a table, or some other customized report.

Interaction zone 260 defines a region in which users may interact using social networking system 210. In FIG. 4, interaction zone 260 is represented as a circle with a radius R, but it may be any size and shape with an appropriate characteristic dimension R.

Preferably, the size of the interaction zone is set to be small enough that users can physically see one another, speak with one another, and/or approach one another. Suitable lengths for characteristic dimension R range between 10-3000 ft, including 10, 20, 50, 100, 150, 200, 400, 800, and 2000 ft. Larger and smaller interaction zones are possible, with smaller interaction zones providing more opportunities for in-person interaction and larger interaction zones providing more opportunities to interact via social networking system 210 with a larger number of users. An interaction zone with a characteristic dimension R of less than 100 feet has been found to be particularly beneficial for fostering in-person interaction.

The size of interaction zone 260 may be selectively modified, either by a social networking system administrator, by a user, or both. In some examples, the social networking system administrator grants users, or a subset of users, such as just commercial users or just personal users, privileges to adjust the size of their interaction zones. In other examples, the administrator fixes the interaction zone size and the users are not able to modify it.

As shown in FIG. 2, server 220 includes memory 222 and server processor 224. Server 220 is connected to a network, such as wide area network 230, and configured to exchange data over the network. Server 220 may include features suitable for use with any known or later developed computer server, such as power supplies, network interface cards, random access memory, and controllers. Server processor 224 may embody any known computer processor (or microprocessor) technology currently known later developed. However, server processor 224 is uniquely programmed to carry out novel social networking methods described herein.

Likewise, memory 222 may embody any known or later developed form of computer memory for storing data, such as solid-state memory, rotating media memory, tape memory, and the like. Memory 222 is used to store user profile data. User profiles may include any relevant information about a given user, such as name, gender, relationship status, employment status, interests, hobbies, education, and experience, etc. User profile data may include one or more offers to be offered to nearby users by a given user, such as a commercial user. The offers may include discounts, advertisements, and coupons with or without requirements for accepting the offer.

As shown in FIG. 2 server processor 224 is programed with instructions to execute social networking method 310. Social networking method 310 includes receiving current geographic position data for each user at step 312, calculating an interaction zone 260 for each user corresponding to a predetermined area around the each users' current geographic position at step 314, cross referencing the interaction zones for each user and identifying users with current geographic positions within other users' interaction zones at step 316; and, for a given interaction zone of a give user, serving to the given user the user profiles of other users with current geographic positions within the given interaction zone of the given user at step 318.

Receiving current geographic position data for each user at step 312 may include instructions to dynamically receive geographic position data. For example, the server processor may be programmed to poll for geographic position data on a regular interval, such as every hour, every minute, every second, or every given fraction of a second. More frequent updates will give more accurate, real-time geographic position data for the users at the expense of more bandwidth. The frequency of position data polling may be adjusted based on bandwidth availability.

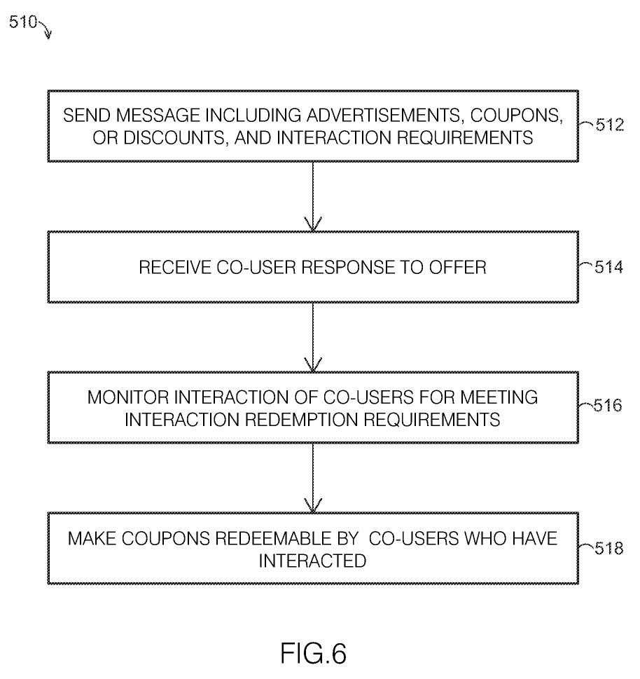

With reference to FIG. 6, a supplemental social networking method 510 for commercial applications and executable by server processor 224 will now be described. Social networking method 510 enables a business user to interact with other users (who may be referred to as consumers or natural persons) by offering the other users discounts, coupons, or advertisements with interaction requirements for redemption of such coupons or discounts. For instance, a business user might offer a ten-percent discount for a group of users within the business user's interaction zone who meet a requirement of all having accepted a “hit” from or interacted in person with each user in the group. FIG. 6 shows one example of a social networking method that a business may use to offer advertisements and discounts to other nearby users.

As can be seen in FIG. 6, social networking method 510 includes sending a message including advertisements, coupons, or discounts, and interaction requirements to users within a business user's interaction zone at step 512, receiving the other users' (also known as consumers') response to the offer at step 514, monitoring the interaction of co-users to determine if they have met the interaction redemption requirements at step 516, and making the offer redeemable by co-users who have satisfied the interaction requirements at step 518.

A wide variety of redemption requirements may he employed. For example, some redemption requirements may pertain to the size of the group necessary to redeem while others may require a certain level of interaction between the users in the group. For example, a required level of interaction between the users in the group may be in-person interaction. A sampling of the interaction requirements envisioned include requiring the users in the group to share their profiles with one another, to introduce themselves in person to one another, to come to the counter of the business together, and/or to send a group message to the business user. A group size redemption requirement may be that the offer is redeemable only by a group of two, three, six, or ten or more people.

In an example where one user is a business, the system may also cross reference other users profile data in order that a desired demographic may he targeted for particular advertisements, coupons, and discounts. Indeed, the business user may direct advertisements, coupons, or discounts towards a consumer user based upon the user profile data of the consumer user,

Turning attention back to FIG. 2, user device 240 includes a device processor 242, a display 244, and a geographic positioning device 246. User devices may include any feature common to conventional user devices, such as graphic processing units, keypads, touchscreens, speakers, microphones, and wireless data communication components, such as cellular radios or WiFi radios. User devices may he mobile, such as a smart phone, or stationary, such as a desktop computer.

With reference to user device 240i in FIG. 3, the reader will see that user device 240i includes a housing, a processor 242i mounted within the housing, a display 244i mounted to the housing, and a geographic positioning device 246i mounted within the housing.

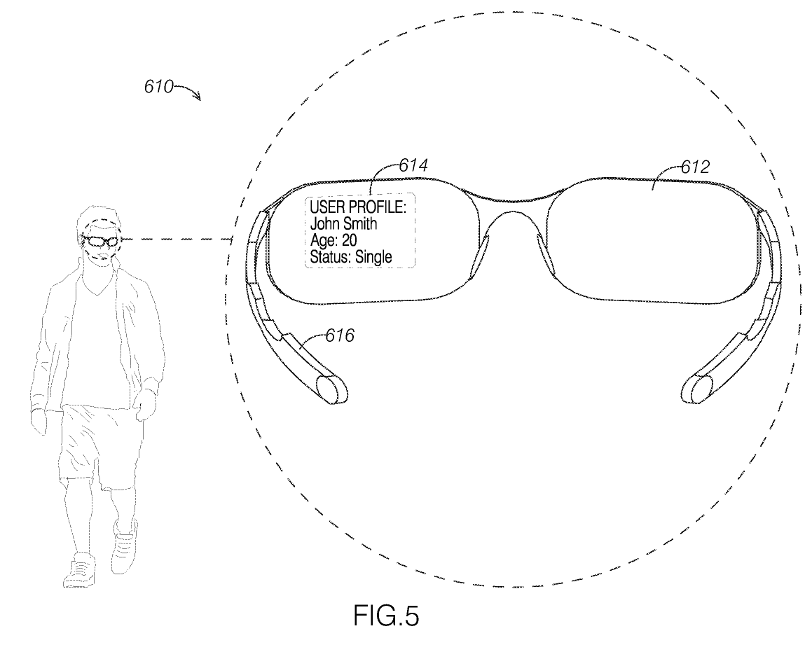

The display may be any conventional or later developed device for graphically displaying data from a processor or graphics processing unit. In some examples, such as shown in FIG. 5, the display is used in conjunction with a lens of a pair of eyeglasses.

As discussed above, the interaction zone is populated with users whose geographic positions fall within the characteristic distance, for example, a radius, of a given user's interaction zone. The geographic positions of these users are ascertained by global positioning device 246 of user device 240. In one embodiment the user device may rely upon a Global Positioning System device (GPS) while in another it may rely upon an alternate form of geographic positioning. In another embodiment for instance, user device 240 may rely upon cell tower triangulation, local area network positioning, radio-frequency identification, or Bluetooth®. User device 240 may rely on any known or later developed technique for ascertaining the device's current geographic position. By establishing the current geographic position of the user device, the social networking system can establish a relative location of a given user and other users in the given user's vicinity.

The geographic positions of all users may be updated dynamically and may be refreshed on a timed interval, upon login, or according to user input. This allows all users to interact with a constantly updated group of co-users. Server 220 is programmed to receive geographic position data from user device 240. Server 220, through processor 224, cross-references the geographic locations of all users and additionally cross-references each user's interaction zone radius. In this way each user's interaction zone can be populated with profile data of all nearby users and each user in turn has the opportunity to interact with another.

FIG. 4, for example, shows a first user in conjunction with user device 240 within interaction zone 260. First user 212's interaction zone includes co-users 214-219. In this example, user device 240 displays profile data for co-users 214-219 to first user 212. First user 212 would then be prompted to “hit” a co-user or be “hit” by a co-user. This “hit” could include an exchange of personal information, photographs, videos, songs, contain a text message, or any combination of electronic data exchange.

In some examples, the profile data displayed to other users is selectively determined in advance by the user to whom the profile belongs. In such examples, the profile data is stored and ready to send to other users in a message or “hit” based upon user input at the time of an interaction. In yet other examples, the profile information and messaging may change based upon the type of users and desired interaction.

For instance, as described above, user 212 may be a business and may have in its profile certain advertisements, coupons, or discounts. If user 212 was a business user with stored offers in its profile, each other user 214-219 would see this profile displayed and have an opportunity to interact with user 212 as potential customers.

In addition to the variety of users, user profiles, and messaging types, the devices designed to interact with these social networking system are equally varied. In one example in FIG. 3 at 240iii for instance, we have a network capable device in the form of eyeglasses. Here the user may year the eyeglasses and view profile information displayed on a lens 612 (shown in FIG. 5).

With reference to FIG. 5, user device 610 is in the form of a pair of eyeglasses specially configured to display user profile data onto lens 612. Eyeglasses 610 include a frame 616, lenses 612, and an onboard display 614. Eyeglasses 610 may be any known or later developed pair of eyeglasses configured to display information on a lens or onto a display incorporated within a lens. Several examples of such eyeglasses are described in U.S. patent application Ser. No. 12/869,481, which is incorporated by reference. The eyeglasses form of a user device may include one or more of a processor, memory, or a geographic positioning device supported on the frames, or the display may connect via a wire or wirelessly to one or more of a;processor, memory, and geographic positioning device. For example, the eyeglasses may connect via a cable to a smartphone, such as an iPhone, which includes a processor, memory, and geographic positioning device.

Display 614 is configured to display profile information of other users within the interaction zone of the user of eyeglasses 610. Display 614 may be an LCD display, a projected image, such as a “heads-up-display,” or a hologram, and the like. In some examples, the lens itself is the surface onto which the display projects the image. In some examples, the onboard display in conjunction with a appropriately programmed processor is configured to display the profile of a co-user in a position on the lens adjacent position of the co--user as seen through the lens. The eyeglasses network capable device provides hands--free networking and a more interactive interaction.

Some types of network capable devices, of which the above-mentioned glasses are only one example, need only be operatively connected to processor 242 and global positioning device 246. This means that in one embodiment the display 244i could be physically connected to a processor or global positioning device while in another the display 244i is physically separate. FIG. 3 at 240i for example shows a network capable device comprised of a housing which contains the processor 242i and geographic positioning device 246i, while the display 244i can be either attached or unattached.

As shown in FIG. 2, device processor 244 is programmed to execute social networking method 410. Social networking method 410 includes uploading current geographic position data of the given user obtained from the geographic positioning device to the server at step 412, receiving user profile data corresponding to other users within the interaction zone or the given user at step 414, displaying the user profile data of the other users within the given user's interaction zone on the display at step 416, receiving input from the given user to send a message to a selected other user within the given user's interaction zone at step 418, and sending the message to the selected other user within the given user's interaction zone at step 420.

Receiving user profile information from other users within the interaction zone at step 414 may occur automatically, at scheduled intervals, or upon user input affirmatively requesting profile information. In a preferred example, the profile information is received automatically upon new users entering the interaction zone and the user receives a notification that a new user profile is available for viewing, such as an audible notification, a vibration notification, or a pop-up visual notification on the display.

In some examples, the device processor and/or the server processor is programed with instructions to exclude profile information from being received by or shared with a given user or a category of users. For example, a user may blacklist a given user with whom she does not wish to share profile information or “hits”. Additionally or alternatively, a user may indicate that she does not wish to receive “hits” from a category of users, such a men, women, people with a relationship status of single, or people above or below a certain age.

The programmed profile sharing exclusion may be temporary or ongoing. For example, a user may indicate that she does not wish to receive profile information from other users during a certain timeframe, such as during business hours. Additionally or alternatively, the user may selectively exclude profile sharing while her relationship status is in a relationship.

Sending the message to the selected other user within the given user's interaction zone at step 420 may include sending the other user a text message. Additionally or alternatively, sending a message at step 420 may include sending an email or a specialized form or document, such as a profile page with or without a personalized message. When included in the customized form, the personalized message may be prepared by the user in advance and/or updated for a given user.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes ad novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A social networking system for users to find and communicate with each other within a limited geographic area, the social networking system comprising:
a server connected to a wide area network and configured to exchange data over the wide area network, the server including:
memory to store user profile data;
a server processor programmed with instructions to:
receive current geographic position data for each user;
calculate an interaction zone for each user corresponding to a predetermined area around the each users' current geographic position;
cross reference the interaction zones for each user and identify users with current geographic positions within other users' interaction zones; and
for a given interaction zone of a given user, serve to the given user the user profiles of other users with current geographic positions within the given interaction zone of the given user; and
a network capable device used by the given user and configured to exchange data over the wide area network, the network capable device including:
a display,
a geographic positioning device, and
a device processor operatively connected to the display and to the geographic positioning device, the device processor being programmed with instructions to:
upload current geographic position data of the given user obtained from the geographic positioning device to the server;
receive user profile data corresponding to other users within the interaction zone of the given user;
display the user profile data of the other users within the given user's interaction zone on the display;
receive input from the given user to send a message to a selected other user within the given user's interaction zone; and
send the message to the selected other user within the given user's interaction zone.

2. The social networking system of claim 1, wherein the network capable device includes a pair of eyeglasses having a lens and the display is associated with the lens.

3. The social networking system of claim 2, wherein the eyeglasses are physically separate from the device processor.

4. The social networking system of claim 2, wherein the eyeglasses are physically separate from the geographic positioning device.

5. The social networking system of claim 2, wherein:
the users include a first user and a second user; and
the user profile data of the second user is displayed on the display of the first user in a position adjacent to the second as seen the first user through the lens.

6. The social networking system of claim 1, wherein:
the users include a first user who is a potential customer and a second user which is a business; and
the user profile data corresponding to the second user includes one or more of advertisements, coupons, or discounts offered by the second user.

7. The social networking system of claim 1, wherein the server is configured to receive dynamically updated current geographic position data for each user.

8. The social networking system of claim 1, wherein the interaction zone may be variably resized based upon user input.

9. The social working system of claim 1, wherein the interaction zone is less than one hundred feet.

10. The social networking system of claim 1, wherein the geographic positioning device is a global positioning system.

11. The social networking system of claim 1, wherein the device processor is further programmed to stamp received messages from other users with the time and the dynamically updated geographic position of the other user at the time the message was sent.

12. The social networking system of claim 1, wherein the network capable device includes a housing and mounted within the housing are the processor and the geographic positioning device.

13. The social networking system of claim 12, wherein the display is attached to the housing.

14. The social networking system of claim 1, wherein the message to the selected other users includes a text message.

15. A social networking system for selectively exchanging data over a wide area network with network capable devices of users within a limited geographic area of each other, the social networking system comprising a server including:
a network interface device configured to connect to the wide area network and to selectively exchange data over the wide area network with network capable devices;
memory to store user profile data, the user profile data including a first user profile corresponding to a first user who is a natural person and a second user profile corresponding to a second user, which is a business, the second user profile including one or more of advertisements, coupons, or discounts offered by the second user;
a server processor programmed with instructions to:
receive dynamically updated current geographic position data for each user;
calculate an interaction zone for each user corresponding to a predetermined area around the each users' current geographic position;
cross reference the interaction zones for each user and identify users with current geographic positions within other users' interaction zones; and
for a given interaction zone of a given user, serve to the given user the user profiles of other users with current geographic positions within the given interaction zone of the given user.

16. The social networking system of claim 15, wherein the advertisements, coupons, or discounts offered by the second user are directed towards a first user based upon the user profile data of the first user.

17. The social networking system of claim 15, wherein the advertisements, coupons, or discounts offered by the second user are made redeemable only to a group of two or more users.

18. The social networking system of claim 15, wherein the geographic position data is updated dynamically by the user.

19. The social networking system of claim 15, wherein the advertisements, coupons, or discounts offered include redemption requirements requiring that the users interact before the users may redeem the offered advertisements, coupons, or discounts.

20. The social networking system of claim 19, wherein the redemption requirements include a requirement that the users must interact in person before the users may redeem the offered advertisements, coupons, or discounts.
